(19) United States
(12) Patent Application Publication
(10) Pub. No.: US 2026/0261184 A1
(43) Pub. Date: Sep. 3, 2026

(54) DRIVE ACTUATOR AND ELECTRONIC DEVICE

(71) Applicant: Goertek Inc., Weifang, Shandong (CN)

(72) Inventors: TOMOKUNI WAUKE, Shandong (CN); Haiyang Ding, Shandong (CN); Hiroyuki Kobayashi, Shandong (CN)

(73) Assignee: Goertek Inc., Weifang, Shandong (CN)

(21) Appl. No.: 18/870,831

(22) PCT Filed: Nov. 4, 2022
(86) PCT No.: PCT/CN2022/129977

§ 371 Date: Dec. 2, 2024

(30) Foreign Application Priority Data
May 31, 2022 (CN) 202210612058.6

(51) Int. Cl. H02K 7/102; G06F 3/01; H02K 33/18

(52) U.S. Cl. CPC H02K 7/102; G06F 3/016; H02K 33/18

(57) ABSTRACT

The disclosure includes a drive exciter, including a housing, a vibration part and a braking part, the housing provided with an accommodation cavity; the vibration part includes an outer shell and a vibration member, the outer shell is fixed in the accommodation cavity and has a vibration chamber formed in the outer shell, and the vibration member is provided in the vibration chamber; the braking part includes a drive member fixed in the accommodation cavity and a braking assembly connected to an output end of the drive member; wherein the drive member drives the braking assembly to move away from or approach the vibration part, so that the braking assembly is spaced apart from or elastically abuts against the vibration member.

### CROSS-REFERENCE TO RELATED APPLICATIONS

The present disclosure is a National Stage of International Application No. PCT/CN2022/129977, filed on Nov. 4, 2022, which claims priority to a Chinese patent application No. 202210612058.6 filed with the CNIPA on May 31, 2022, both of which are hereby incorporated by reference in their entireties.

### TECHNICAL FIELD

The present disclosure relates to the technical field of a vibration apparatus, and particularly to a drive exciter and an electronic device.

### BACKGROUND

A traditional vibration apparatus produces an illusion of a force “seemingly directed in a certain direction” by continuously producing asymmetric vibrations. However, to create this illusion, not only does the skin need to undergo shear deformation, which restricts the way the device can be held, but it is also necessary to limit the vibration frequency to a perceptible range, and the stimulation must be continued for a period of time.

As a means of reproducing force sensations, there is now a method to input an asymmetric signal to a linear resonator and use the human senses to generate the illusion. This method, in principle, can only produce a continuous directional force sensation and cannot achieve discrete vibration outputs. The equivalent force perceived through this method is relatively small, and the asymmetric signal also generates excessive vibrations, making it difficult to obtain a clear direction-sense.

In summary, the conventional vibration apparatus has many limitations in practical application that are not limited to the above problems.

### SUMMARY

The main objective of the present disclosure is to provide a drive exciter, intended to discretely present clear and distinct anisotropic vibrations.

To achieve the above objective, the present disclosure proposes a drive exciter, comprising:
a housing provided with an accommodation cavity;
a vibration part comprising an outer shell and a vibration member, wherein the outer shell is fixed in the accommodation cavity and has a vibration chamber formed in the outer shell, and the vibration member is vibratably provided in the vibration chamber; and
a braking part comprising a drive member fixed in the accommodation cavity and a braking assembly connected to an output end of the drive member;
wherein the drive member drives the braking assembly to move away from or approach the vibration part, so that the braking assembly is spaced apart from or elastically abuts against the vibration member.

In an embodiment of the present disclosure, the braking assembly includes:
a transmission member connected to the output end of the drive member; and
a braking member provided on a surface of the transmission member facing the vibration part and configured to abut against the vibration member.

In an embodiment of the present disclosure, the braking member is a spring;
or, the braking member is rubber;
or, the braking member is foam;
or, the braking member is composed of at least two of a spring, rubber, and foam connected in series or in parallel.

In an embodiment of the present disclosure, the drive member is provided with a rotation shaft, one end of the transmission member being connected to the rotation shaft, an axis direction of the rotation shaft being parallel to a vibration direction of the vibration member, and the braking member being provided on one end of the transmission member away from the rotation shaft;
or, the drive member drives the transmission member to move linearly, with a motion direction of the transmission member provided at an angle with the vibration direction of the vibration member.

In an embodiment of the present disclosure, the vibration member includes:
two spring leaves connected to the outer shell, and provided on two opposite sides of the outer shell respectively; and
a vibrator provided vibratably in the vibration chamber, with two ends of the vibrator connected to the two spring leaves respectively;
the braking assembly is spaced apart from or elastically abuts against the spring leaves.

In an embodiment of the present disclosure, the vibration part further includes a cushioning member, the cushioning member is provided on one side of one of the spring leaves which faces the braking assembly and is located proximate thereto, and a center of the cushioning member is coaxial with centers of the spring leaves.

In an embodiment of the present disclosure, the drive member is a double axis motor, there are provided two braking assemblies, two output ends of the drive member are respectively connected to one of the braking assemblies, and the two braking assemblies are staggered in an axial direction of the drive member.

In an embodiment of the present disclosure, the drive exciter includes at least one braking part and at least two vibration parts, and the braking assembly of one of the braking part is provided at least corresponding to one of the vibration parts.

In an embodiment of the present disclosure, at least one installation platform is provided protruding from a cavity wall of the accommodation cavity, and divides the accommodation cavity into at least two sub-cavities;
a plurality of support ribs are provided protruding from cavity walls of the sub-cavities, side edges of the support ribs are indented to form installation slots, and the support ribs form braking slots with an inner wall of the accommodation cavity;
the vibration part is provided in the installation slot, and the braking assembly is movably provided in the braking slot.

The present disclosure further relates to an electronic device, comprising the drive exciter according to any one of the above embodiments.

The technical solution of the present disclosure, by enabling the movably arranged braking assembly to abut against the vibration part discretely or at intervals, brakes the vibration part to generate the anisotropic vibrations, and since the generation of these anisotropic vibrations requires the cooperation of the braking part and the vibration part, the frequency of generating the vibrations depends on how often the braking assembly moves and abuts against the vibration member, and thus when the braking assembly continuously moves to switch between a state of being spaced apart from the vibration member and a state of abutting against it, it is possible to generate the anisotropic vibrations discretely.

The technical solution of the present disclosure may significantly increase the asymmetry of the anisotropic vibrations and present asymmetric vibrations discretely over a short period of time. Moreover, by generating vibrations that are close to the asymmetrical vibration force that actually occurs, it is possible to discretely present a clear force sensation in a certain direction for a short period of time, and the direction of this force sensation depends on the direction in which the braking assembly abuts against the vibration part, and is no longer limited to the manner of holding.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 is a schematic structural diagram of one embodiment of the drive exciter according to the present disclosure;

FIG. 2 is a partial schematic structural diagram of one embodiment of the drive exciter according to the present disclosure;

FIG. 3 is an enlarged schematic diagram of area A in FIG. 2;

FIG. 4 is an exploded schematic structural diagram of a vibration part of one embodiment of the drive exciter according to the present disclosure;

FIG. 5 is a schematic structural diagram of a housing of one embodiment of the drive exciter according to the present disclosure;

FIG. 6 is a schematic structural diagram of another embodiment of the drive exciter according to the present disclosure;

FIG. 7 is a schematic diagram of an energy storage phase of one embodiment of the drive exciter according to the present disclosure;

FIG. 8 is a schematic diagram of a motion phase of one embodiment of the drive exciter according to the present disclosure;

FIG. 9 is a schematic diagram of a braking phase of one embodiment of the drive exciter according to the present disclosure;

FIG. 10 is a schematic diagram of a returning phase of one embodiment of the drive exciter according to the present disclosure.

### DESCRIPTION OF REFERENCE SIGNS

| No. | Name | No. | Name |
|---|---|---|---|
| 100 | drive exciter | 33a | vibration chamber |
| 10 | housing | 35 | vibration member |
| 10a | accommodation cavity | 351 | spring leaf |
| 11 | installation platform | 353 | vibrator |
| 13 | support rib | 50 | braking part |
| 13a | installation slot | 51 | drive member |
| 13b | braking slot | 53 | braking assembly |
| 30 | vibration part | 531 | transmission member |
| 31 | cushioning member | 533 | braking member |
| 33 | outer shell | | |

The realization of the purpose, functional features and advantages of the present disclosure will be further described in conjunction with the embodiments and with reference to the accompanying drawings.

### DETAILED DESCRIPTION

Technical solutions in the embodiments of the present disclosure are described below with reference to the accompanying drawings in the embodiments of the present disclosure. Apparently, the described embodiments are merely some rather than all of the embodiments of the present disclosure. All other embodiments, acquired by those of ordinary skill in the art based on the embodiments of the present disclosure without any creative work, should fall into the protection scope of the present disclosure.

It should be noted that all directional indications (such as up, down, left, right, front, rear . . . ) in the embodiments of the present disclosure is only used to explain the relative position relationship between the components under a particular attitude (as shown in the attached drawing), the motion, etc., and if the specific attitude changes, the directional indication will change accordingly.

In addition, descriptions involving “first”, “second”, etc., in the present disclosure are used solely for descriptive purposes and should not be construed as indicating or implying their relative importance or as implicitly specifying the number of the indicated technical features. Thus, features defined by “first”, “second”, etc., may explicitly or implicitly include at least one such feature. Furthermore, technical solutions from different embodiments can be combined, but must be based on what an ordinary skilled person in the art could achieve. When the combination of technical solutions results in mutual contradictions or impossibility of implementation, such combinations should be considered non-existent and outside the scope of protection claimed in the present disclosure.

The so-called “anisotropic vibration”, also known as “asymmetric vibration” creates a sensation for the user holding the vibration device of being pulled in a specific direction by inputting an asymmetrical signal to the vibration apparatus such as a vibration motor, etc. Moreover, vibration apparatuses capable of achieving anisotropic vibration are commonly used in devices such as game controllers and provide users with excellent feedback through asymmetric vibration.

In the vibration apparatus involved in the technical solution of the present disclosure, the so-called “discrete” is a concept that contrasts with “continuous”. For example, after a single excitation, the vibration motor will continuously vibrate to output a continuous vibration to the vibration apparatus, such that the user feels a vibration or pulling sensation that lasts for a period of time, it is referred to as the continuous vibration; however, if the vibration apparatus outputs a clear vibration directed toward a specific direction once or multiple times at intervals over a period, it is referred to as the discrete anisotropic vibration.

It should also be noted that due to the relatively small equivalent force, the traditional vibration apparatus often need to continuously output vibrations within a certain frequency range to ensure that the user can clearly perceive the vibration, thus generating a pulling sensation. Since the vibrator of the vibration motor has spring plates connected to both ends thereof, even after a single excitation, residual vibrations will still occur in the vibration motor under the effect of the spring plates following a strong vibration of the vibrator.

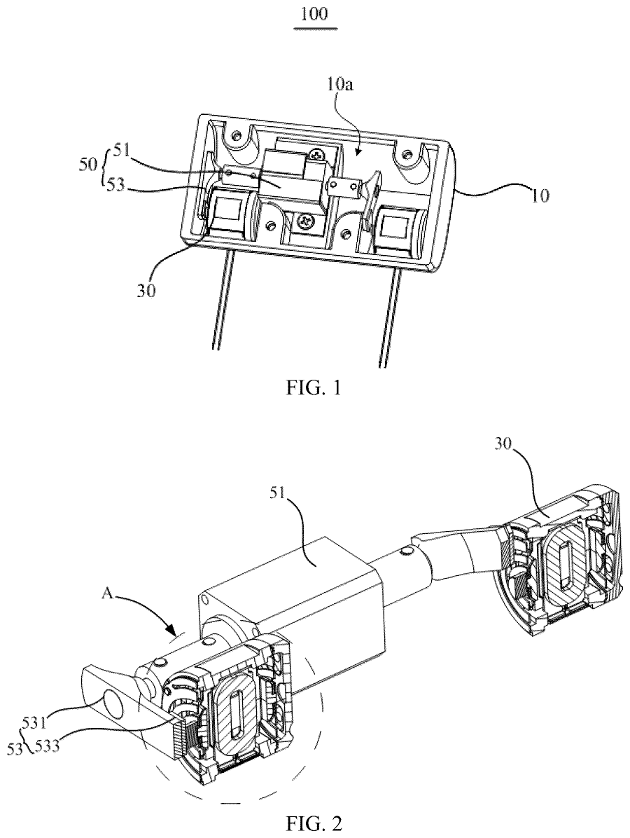

Referring to FIGS. 1 to 10, to achieve the objective of discretely presenting clear and definite anisotropic vibrations, the drive exciter 100 provided by the present disclosure includes a housing 10, a vibration part 30 and a braking part 50, the housing 10 provided with an accommodation cavity 10a; the vibration part 30 includes an outer shell 33 and a vibration member 35, the outer shell 33 is fixed in the accommodation cavity 10a and has a vibration chamber 33a formed in the outer shell 33, and the vibration member 35 is vibratably provided in the vibration chamber 33a; the braking part 50 includes a drive member 51 fixed in the accommodation cavity 10a and a braking assembly 53 connected to an output end of the drive member 51; wherein the drive member 51 drives the braking assembly 53 to move away from or approach the vibration part 30, so that the braking assembly 53 is spaced apart from or elastically abuts against the vibration member 35.

In one embodiment, the outer contour of the housing 10 is roughly cylindrical, with its interior hollow forming the accommodation cavity 10a. The vibration part 30 is composed of a structure capable of mechanically storing energy; for example, the vibration part 30 may be a linear resonator, inside which there is the vibration member 35 that vibrates in a certain direction. It can be understood that the vibration member 35 has a certain mass to possess sufficient energy during vibration.

Optionally, in the present embodiment, the drive member 51 may be a linear motor, solenoid, linear actuator, rotary motor, or other drive device, and drives the braking assembly 53 to approach or move away from the vibration part 30 either by translation or rotation.

Optionally, the braking assembly 53 may be a structure equipped with a damper, so as to brake the vibration member 35 and generate a vibration wave.

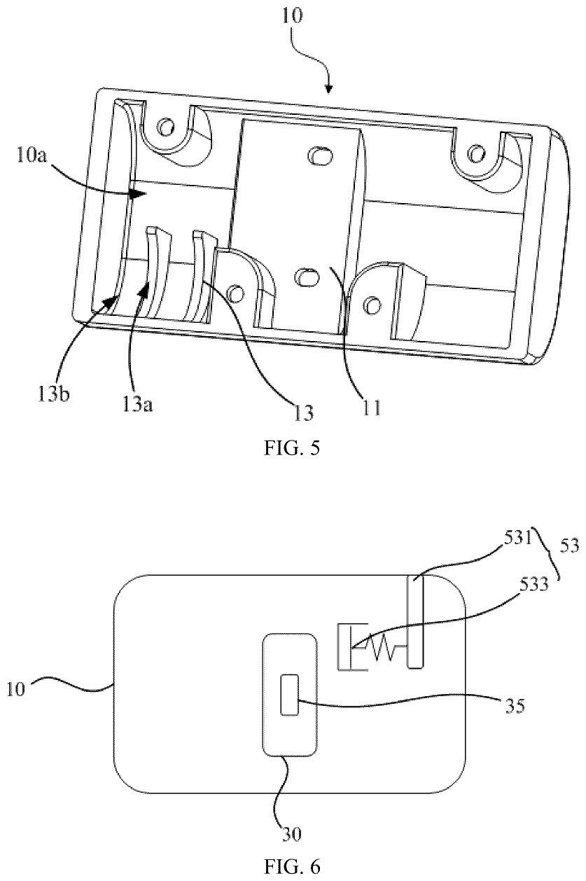

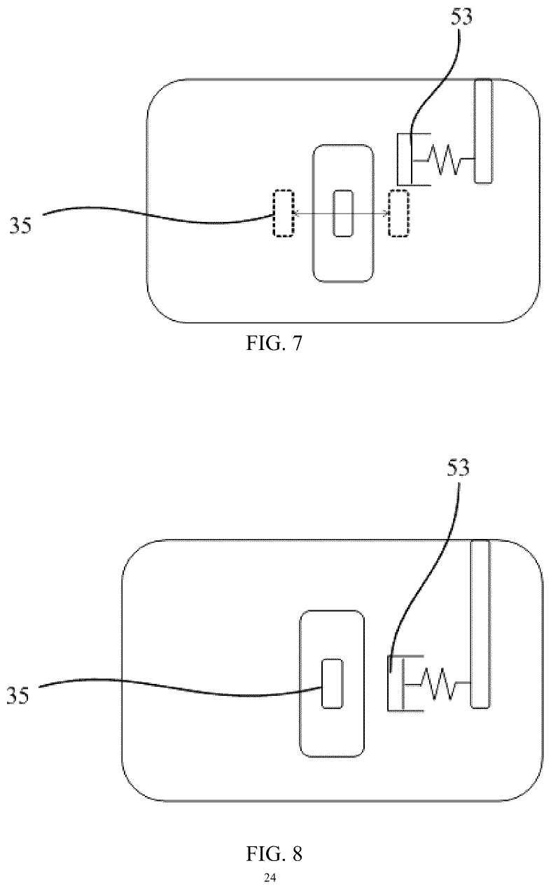

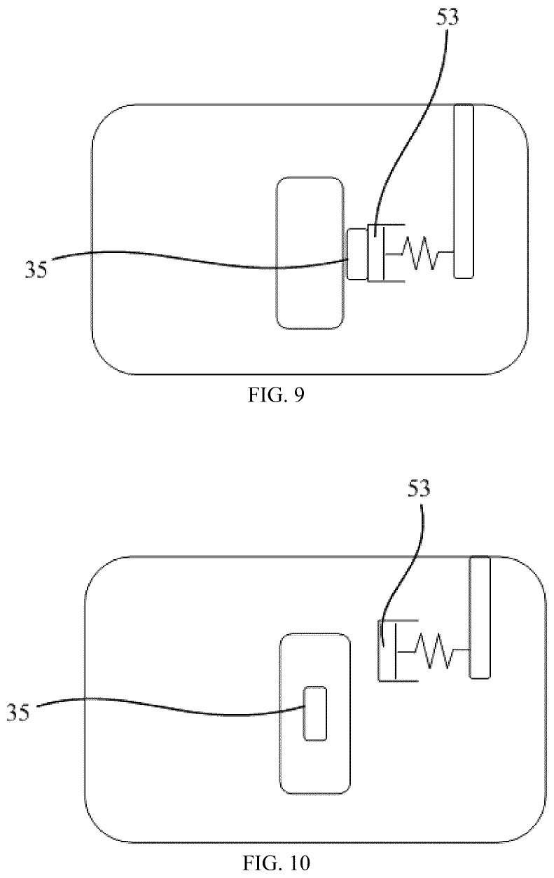

Referring to FIGS. 6 to 10, in one embodiment, it is necessary for the drive exciter 100 to go through the following stages to produce a complete anisotropic vibration:
energy storage stage: referring to FIG. 7, inputting an electric drive signal to the vibration part 30, and generating an excitation magnetic field in the vibration chamber 33a so as to drive the vibration member 35 to vibrate continuously for storing energy;
motion stage: referring to FIG. 8, the drive member 51 drives the braking assembly 53 to move to the vibration path of the vibration member 35, during which the braking assembly 53 does not interfere with the vibration of the vibration member 35;
braking stage: referring to FIG. 9, the braking assembly 53 abuts against the vibration part 30, brakes the vibration member 35, receives the energy produced by the vibration of the vibration member 35 to thus generate the anisotropic vibration, and generates a pulling sensation or force sensation in a normal direction of the contact surface between them;
returning stage: referring to FIG. 10, after the anisotropic vibration is generated once, the drive member 51 drives the braking assembly 53 to reset and waits for the next trigger, and the anisotropic vibration stops.

It can be understood that in the present embodiment, the generation of the anisotropic vibration does not originate from the vibration of the vibration part 30 itself, but rather from the cooperation between the braking part 50 and the vibration part 30, i.e., the braking assembly 53 brakes the vibration part 30 to generate the anisotropic vibration, and when the braking assembly 53 leaves the vibration part 30, the anisotropic vibration stops.

After going through the above stages, the drive exciter 100 may generate the anisotropic vibration once. Repeating the above processes multiple times within a certain period may discretely generate multiple instances of anisotropic vibration. Further, by controlling the motion frequency of the braking assembly 53, it is possible to control the frequency of generating the anisotropic vibration, and by changing parameters such as the mass of the vibration member 35, it is possible to change the magnitude of the anisotropic vibration.

The technical solution of the present disclosure, by enabling the movably arranged braking assembly 53 to abut against the vibration part 30 discretely or at intervals, brakes the vibration part 30 to generate the anisotropic vibrations, and since the generation of these anisotropic vibrations requires the cooperation of the braking part 50 and the vibration part 30, the frequency of generating the vibrations depends on how often the braking assembly 53 moves and abuts against the vibration part 30, and thus when the braking assembly 53 continuously moves to switch between a state of being spaced apart from the vibration part 30 and a state of abutting against it, it is possible to generate the anisotropic vibrations discretely.

The technical solution of the present disclosure may significantly increase the asymmetry of the anisotropic vibrations and present asymmetric vibrations discretely over a short period of time. Moreover, by generating vibrations that are close to the asymmetrical vibration force that actually occurs, it is possible to discretely present a clear force sensation in a certain direction for a short period of time, and the direction of this force sensation depends on the direction in which the braking assembly 53 abuts against the vibration part 30, and is no longer limited to the manner of holding.

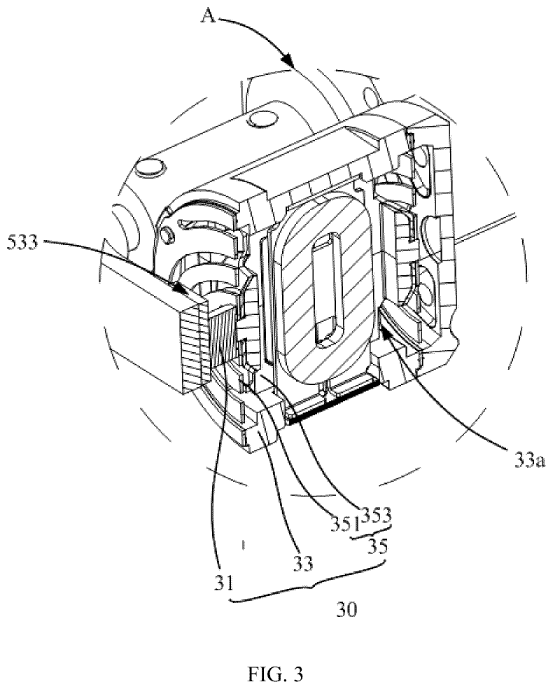

Referring to FIGS. 2 and 3, in one embodiment of the present disclosure, the braking assembly 53 includes a transmission member 531 and a braking member 533. The transmission member 531 is connected to the output end of the drive member 51; and the braking member 533 is provided on a surface of the transmission member 531 facing the vibration part 30 and is configured to abut against the vibration member 35.

In the present embodiment, the braking part 50 is provided on the side where the drive part is located. Specifically, the braking part 50 further includes a connecting piece that wraps around the drive member 51 and is bolted to the housing 10. The drive member 51 is fixed in the accommodation cavity 10a via the connecting piece. When receiving a signal, the drive member 51 drives the transmission member 531 to move, such that the braking member 533 abuts against the vibration member 35 or moves away from the vibration member 35.

The transmission member 531 is made of a material with a certain strength and rigidity, thereby providing good structural support for the braking member 533, ensuring structural stability and achieving good braking performance.

Optionally, in one embodiment of the present disclosure, the braking member 533 is a spring; or, the braking member 533 is rubber; or, the braking member 533 is foam; or, the braking member 533 is composed of at least two of a spring, rubber, and foam connected in series or in parallel. That is to say, two or three of the spring, the rubber and the foam may be sequentially arranged end to end so as to obtain a good braking effect, or arranged side by side to brake the vibration member 35 and ensure structural stability.

By adopting the above-described material and structure having a certain degree of elasticity, when the braking member 533 abuts against the vibration part 30, it is possible to have a good braking effect and protect the braking part 50 and the vibration part 30 to a certain extent.

Referring to FIG. 2, in one embodiment of the present disclosure, the drive member 51 is provided with a rotation shaft, one end of the transmission member 531 is connected to the rotation shaft, an axis direction of the rotation shaft is parallel to a vibration direction of the vibration member 35, and the braking member 533 is provided on one end of the transmission member 531 away from the rotation shaft. Specifically, in the present embodiment, the drive member 51 is a rotating motor, the transmission member 531 is a substantially L-shaped structural member, and one branch of the transmission member 531 is connected to the rotation shaft through an interlocking structure, and the other branch of the transmission member 531 is provided close to the vibration part 30. When the drive member 51 receives a designated signal, the rotation shaft drives the transmission member 531 to rotate, and the transmission member 531 approaches or moves away from the side where the vibration part 30 is located, until the braking member 533 abuts the vibration member 35, or until the braking member 533 is separated from the vibration member 35.

However, in the embodiment of other aspects of the present disclosure, the drive member 51 drives the transmission member 531 to move linearly, and a motion direction of the transmission member 531 is provided at an angle with the vibration direction of the vibration member 35. Optionally, the drive member 51 may be a linear motor and includes a stator and a rotor, wherein the stator is fixed in the accommodation cavity 10a, the rotor is in sliding fit with the stator and moves along a straight line, and the transmission member 531 is connected to the rotor.

Preferably, the straight line in which the motion direction of transmission member 531 is set at an angle of 90 degrees to the straight line where the vibration direction of the vibration member 35 is located. This arrangement is simple and effective, making the generation and transmission of vibrations more explicit and achieving good results.

Of course, the drive member 51 may also be other structures that can realize the above technical concept, which is not specifically limited. Accordingly, the structure of the transmission member 531 may be modified based on the structure or spatial arrangement of the drive member 51, and is not limited.

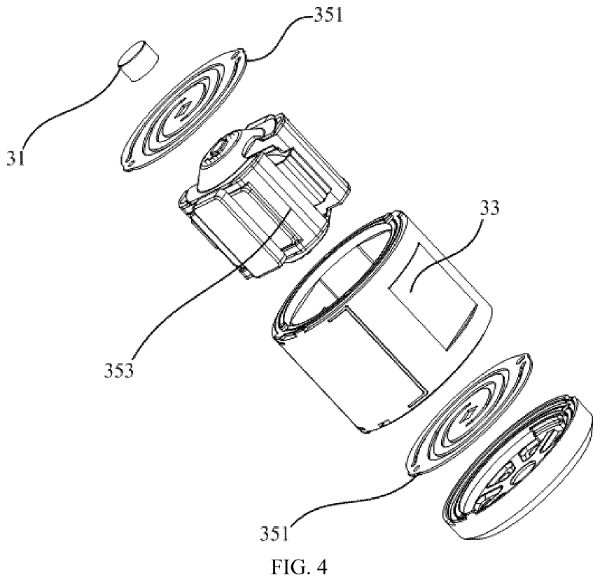

Referring to FIGS. 3 and 4, in one embodiment of the present disclosure, the vibration member 35 includes two spring leaves 351 and a vibrator 353. The two spring leaves 351 are connected to the outer shell 33, and are provided on two opposite sides of the outer shell 33 respectively. The vibrator 353 is provided vibratably in the vibration chamber, wherein two ends of the vibrator 353 are connected to the two spring leaves 351 respectively; the braking assembly 53 is spaced apart from or elastically abuts against the spring leaves 351.

In the present embodiment, the outer shell 33 is substantially cylindrical, and accordingly, the spring leaf 351 is also substantially circular in the outer contour, and is provided with a spiral hollow to increase the elasticity of the spring leaf 351. The two opposite sides of the outer shell 33 are provided with openings in communication with the vibration chamber 33a, the spring leaf 351 blocks the opening, and the end of the vibrator 353 is connected to the center of the spring leaf 351. When the vibrator 353 vibrates, the spring leaf 351 is driven to vibrate to store the generated energy in the spring leaf 351. When the braking assembly 53 abuts against the spring leaf 351, the stored energy is released to the braking member 533 to generate a vibration wave. Since the braking member 533 is provided on one side of the spring leaf 351, the generated vibration is also one-sided, and depending on the characteristics of the braking member 533, the braking member 533 is greatly different from the spring leaf 351 and has obvious asymmetry. That is to say, pulling sensation in a certain direction is real and does not depend on the user's grip and sensory experience.

Further, as shown in FIGS. 3 and 4, in one embodiment of the present disclosure, the vibration part 30 further includes a cushioning member 31, the cushioning member 31 is provided on one side of one of the spring leaves 351 facing the braking assembly 53, the spring leaves 351 are close to the braking assembly 53, and a center of the cushioning member 31 is coaxial with centers of the spring leaves 351. To protect the hardware and achieve good vibration transmission, one side of the vibration part 30 is provided with the cushioning member 31. Generally, the vibration member 35 is connected to the center of the spring leaf 351, which is the area with the largest amplitude and most intense vibration. Therefore, by providing the cushioning member 31 at the center, it is possible to provide good cushioning and damping effects, thereby protecting the structure of the vibration part 30 to some extent; depending on the characteristics of the braking member 533 and the cushioning member 31, they are greatly different from the spring leaf 351 and have more obvious asymmetry.

In the embodiments of the some aspects of the present disclosure, the cushioning member 31 is a spring; or the cushioning member 31 is rubber; or the cushioning member 31 is foam; or the cushioning member 31 is composed of at least two of the spring, the rubber and the foam connected in series or in parallel.

In some embodiments of the present disclosure, the middle of the vibration chamber 33a is fixedly provided with a coil, the vibrator 353 includes a mass block and four permanent magnets, the mass block is hollow to form a guide groove surrounding the line segment, the four permanent magnet are embedded in the mass block in pairs, the two sets of permanent magnets are arranged on two sides of the coil, and the magnetic poles of the two permanent magnets in the same set are oppositely arranged. When the coil is electrified to generate a magnetic field, the mass block is moved under the action of the magnetic field to change the magnetic field, and the motion direction of the mass block also changes. Further, the mass block and the inner wall of the vibration chamber 33a are also provided with a magnetic conduction plate to reduce magnetic leakage and improve the utilization rate of the magnetic field.

In other embodiments, the permanent magnet may also be fixed, the mass block is embedded with a coil, the coil is electrified to generate a magnetic field, and the mass block is moved under the action of the magnetic field. Of course, the setting form and the driving method of the vibration member 35 are not limited to this, and will not be elaborated herein.

Referring to FIG. 2, in one embodiment of the present disclosure, the drive member 51 is a double axis motor, there are provided two braking assemblies 53, two output ends of the drive member 51 are respectively connected to one of the braking assemblies 53, and the two braking assemblies 53 are staggered in an axial direction of the drive member 51.

In the present embodiment, the two output ends of the double axis motor are on the same axis, each output end is connected to one transmission member 531, and one vibration part 30 is provided near each transmission member 531. The transmission member 531 is approximately L-shaped, one branch of the transmission member 531 is connected with the rotation shaft through a linkage structure, and the other branch of the transmission member 531 is provided close to the vibration part 30. Two branches of the transmission members 531 are perpendicular to each other, and when observing the braking assembly 53 along the axis of the output ends of the double axis motor, the two transmission members 531 are arranged at an angle. Thus, when the motor rotates, only one braking member 533 abuts one vibration part 30 at the same time; however, when the drive member 51 rotates by the same angle, the two braking assemblies 53 abuts against the vibration part 30 in sequence, that is, this arrangement may increase the frequency of generating the anisotropic vibration and improve the efficiency.

In another embodiment of the present disclosure, the braking assemblies 53 may also be arranged in parallel or in the same plane, that is, when the drive member 51 rotates, two braking assemblies 53 respectively abut against two vibration parts 30 at the same time. In this way, the two braking assemblies 53 and the two vibration parts 30 are connected or disconnected at the same time, and the anisotropic vibrations generated by the two braking assemblies 53 and the two vibration parts 30 are superimposed to generate a stronger force sensation, so that the vibration sensation is clearer.

Or, the two braking assemblies 53 may be independently driven by the two drive members 51, and are controlled by signals to be combined with the vibration part 30 simultaneously or sequentially, so as to achieve diversified vibration effects.

Of course, in other embodiments of the present disclosure, the drive exciter 100 comprises at least one braking part 50 and at least two vibration parts 30, and the braking assembly 53 of one of the braking part 50 is provided at least corresponding to one of the vibration parts 30. That is to say, on the basis of ensuring that one braking assembly 53 at least corresponds to one vibration part 30, a plurality of braking parts 50 are matched with a plurality of vibration parts 30 by applying the principle described in the above embodiment, and thus a variety of discrete anisotropic vibration effects may be produced.

Referring to FIGS. 1, 2 and 5, in one embodiment of the present disclosure, at least one installation platform 11 is provided protruding from a cavity wall of the accommodation cavity 10a, and divides the accommodation cavity 10a into at least two sub-cavities; a plurality of support ribs 13 are provided protruding from cavity walls of the sub-cavities, side edges of the support ribs 13 are indented to form installation slots 13a, and the support ribs 13 form braking slots 13b with an inner wall of the accommodation cavity 10a; the vibration part 30 is provided in the installation slot 13a, and the braking assembly 53 is movably provided in the braking slot 13b.

Referring to FIG. 5, in the present embodiment, the outer shell 33 of the vibration part 30 is cylindrical, and correspondingly, the side edge of the support rib 13 is arc-shaped. The outer shell 33 is embedded in the installation slot 13a and abuts the side edge of the support rib 13. The support rib 13 on one side is spaced from the cavity wall of the accommodation cavity 10a to form the braking slot 13b, and the braking assembly 53 may enter or exit the braking slot 13b rotationally or linearly.

The installation slots 13a and braking slots 13b in adjacent sub-cavities are symmetrically arranged or arranged on the same side, which depends on the specific situation, and is not specifically limited herein.

The present disclosure also relates to an electronic device, which includes the drive exciter 100 described in any of the above embodiments. The specific structure of the drive exciter 100 refers to the above embodiments. Since the electronic device adopts all the technical solutions of the above embodiments, it therefore possesses all the beneficial effects brought by the technical solutions of the above embodiments, which will not be elaborated herein.

In some applications of the drive exciter 100, the electronic device may be a tactile device such as a handle or a VR all-in-one machine.

The above description is merely an optional embodiment of the present disclosure, and is not intended to limit the patent scope of the present disclosure. Any equivalent structural transformations made based on the inventive concept of the present disclosure using the contents of the specification and the accompanying drawings of the present disclosure, or their direct/indirect application in other related technical fields, shall fall within the scope of patent protection of the present disclosure.

1. A drive exciter, comprising:
a housing provided with an accommodation cavity;
a vibration part comprising an outer shell and a vibration member, wherein the outer shell is fixed in the accommodation cavity and comprises a vibration chamber formed in the outer shell, and the vibration member is provided in the vibration chamber; and
a braking part comprising a drive member fixed in the accommodation cavity and a braking assembly connected to an output end of the drive member;
wherein the drive member is configured to drives the braking assembly to move away from or approach the vibration part such that the braking assembly is spaced apart from or elastically abuts against the vibration member.

2. The driving exciter according to claim 1, wherein the braking assembly comprises:
a transmission member connected to the output end of the drive member; and
a braking member provided on a surface of the transmission member facing the vibration part such that the braking member abuts against the vibration member.

3. The driving exciter according to claim 2, wherein the braking member is comprises a spring; or
the braking member comprises rubber; or
the braking member comprises foam; or
the braking member comprises at least two of a spring, rubber, and foam connected in series or in parallel.

4. The driving exciter according to claim 2, wherein the drive member is provided with a rotation shaft, a first end of the transmission member being connected to the rotation shaft, an axis direction of the rotation shaft being parallel to a vibration direction of the vibration member, and the braking member being provided on the first end of the transmission member away from the rotation shaft; or
the drive member is configured to drives the transmission member to move linearly, with a motion direction of the transmission member provided at an angle with the vibration direction of the vibration member.

5. The driving exciter according to claim 1, wherein the vibration member comprises:
two spring leaves connected to the outer shell, and provided on two opposite sides of the outer shell respectively; and
a vibrator provided in the vibration chamber, with two ends of the vibrator connected to the two spring leaves respectively;
wherein the braking assembly is spaced apart from or elastically abuts against the spring leaves.

6. The driving exciter according to claim 5, wherein the vibration part further comprises a cushioning member, the cushioning member being provided on one side of one of the spring leaves which faces the braking assembly and is located proximate thereto, and a center of the cushioning member is coaxial with centers of the spring leaves.

7. The driving exciter according to claim 1, wherein the drive member is a double axis motor comprising two braking assemblies, two output ends of the drive member are respectively connected to one of the braking assemblies, and the two braking assemblies are staggered in an axial direction of the drive member.

8. The driving exciter according to claim 1, further comprises at least one braking part and at least two vibration parts, and a braking assembly of one of the braking part is provided at least corresponding to one of the vibration parts.

9. The driving exciter according to claim 1, wherein at least one installation platform is provided protruding from a cavity wall of the accommodation cavity, and provided dividing the accommodation cavity into at least two sub-cavities;
a plurality of support ribs is provided protruding from cavity walls of the sub-cavities, side edges of the support ribs are indented to form installation slots, and the support ribs form braking slots with an inner wall of the accommodation cavity; and
the vibration part is provided in the installation slot, and the braking assembly is movably provided in the braking slot.

10. An electronic device, comprising a drive exciter according to claim 1.
